(19) United States
(12) Patent Application Publication
(10) Pub. No.: US 2016/0044340 A1
(43) Pub. Date: Feb. 11, 2016

(54) Method and System for Real-Time Video Encoding Using Pre-Analysis Based Preliminary Mode Decision

(71) Applicant: PathPartner Technology Consulting Pvt. Ltd., Bangalore (IN)

(72) Inventors: Praveen Gurujala Bhaktavathsalam, Tiruvallur District (IN); Ramakrishna Adireddy, Visakhapatnam District (IN)

(73) Assignee: PathPartner Technology Consulting Pvt. Ltd., Bangalore (IN)

(21) Appl. No.: 14/820,817

(22) Filed: Aug. 7, 2015

(30) Foreign Application Priority Data
Aug. 7, 2014 (IN) 3889/CHE/2014

(51) Int. Cl. H04N 19/96; H04N 19/159; H04N 19/593; H04N 19/51

(52) U.S. Cl. CPC H04N 19/96; H04N 19/51; H04N 19/159; H04N 19/593

(57) ABSTRACT

The present invention discloses a method and system for real-time video encoding using pre-analysis based preliminary mode decision. The system includes a sequence classifier module 200 to pre-analyze an input video sequence to map the video sequence into one of the pre-defined classes based on statistical parameters. The sequence classifier module 200 includes an activity measuring unit 202 to receive the inputting video sequence and a time delayed version of the video sequence, a statistics collector 204 to collect activity of the video sequence at frame-level and a sequence categorizer 206 to map the input sequence to a prior-defined classes based on the activity statistics of the current frame. The system also includes at least one threshold decider 210 to provide the likely modes of encoding techniques to each of the pre-analyzed video sequence based on the pre-defined classes.

### PREAMBLE TO THE DESCRIPTION

The following specification particularly describes the invention and the manner in which it is to be performed:

### TECHNICAL FIELD OF THE INVENTION

The present invention relates to digital video compression and, in particular, relates to a method and system for real-time video encoding using pre-analysis based preliminary mode decision.

### BACKGROUND OF THE INVENTION

A typical video comprises of 24-30 frames per second, wherein 24-30 still images move every second, in sequence, to give the illusion of movement. During the introduction of digital video, video data is stored in its pure and uncompressed format; therefore, a huge space is needed for storing even a short video footage. For instance, a one-second video footage with a resolution of 1920×1080 pixels, refresh rate of 25 frames/second, and color format 4:2:0 with depth of 8 bit would require about 279.936 GB of space for an hour video. Thus, such huge data causes extremely high transmission power and storage demands even with a powerful computing system. To avoid these problems, a number of video codecs viz. MPEG, have been developed, wherein a significant reduction in the file size can be achieved with little or no adverse effect on the quality of the video.

Video codec is a device or software for compressing or decompressing digital video wherein the resultant compressed video is compatible with a video compression specification. Mostly video codecs combine spatial image compression and temporal motion compensation. The sequence of frames in a video contains spatial and temporal redundancy in which the video compression algorithms attempt to eliminate or code in a smaller size. For encoding, similarities between the frames or differences there between are only stored or perceptual features of human vision are used. For instance, changes in brightness of two adjacent frames are easy to perceive than small differences in color.

In digital video compression, video encoders are computationally intensive and typically non-real time for best quality objective. Hence, video encoding is treated to be more challenging to achieve real-time performance with insignificant impact on video quality. The latest video coding standard i.e., High Efficiency Video Coding (HEVC) is extremely complex compared to its predecessors. It became more complex due to more freedom and higher degree of flexibility provision for the mode selection. These increased number of coding options cause many-fold combinations and so the computational complexity.

Most of the state-of-art techniques are targeted to introduce fast algorithms, commonly applicable to all content types, to achieve real-time performance. In such techniques, the video content properties are not considered for a better trade-off of quality and performance. Few other state-of-art approaches which are based on pre-analysis techniques use feature extraction or foreground vs background classification to improvise the quality of particular region of the frames. This kind of approach often called as Region Of Interest (ROI) coding, and targeted for the purpose of improving quality in a particular region of image/video and they are not really for the purpose of reducing computation time.

Therefore, there is a need of method(s) for real-time video encoding, which makes use of video content properties or characteristics to reduce the computation complexity without compromising on video quality.

### SUMMARY OF THE INVENTION

The present invention overcomes the drawbacks of the prior art by providing a method and system for real-time video encoding using pre-analysis based preliminary mode decision. According to an embodiment, the invention discloses a method for real time video encoding. The method includes step of pre-analyzing an input video sequence to map the video sequence into one of the pre-defined classes based on statistical parameters of the video sequence. The step of pre-analyzing is performed at regular intervals for a particular period of the input video sequence. The method also includes the step of applying a set of likely modes of encoding to the input video sequence based on mapping of the video sequence to the pre-defined classes.

According to a preferred embodiment, the step of pre-analyzing the input video sequence includes the following steps of inputting the video sequence and a time delayed version of the video sequence into an activity measuring unit. The pre-analyzing further includes the step of comparing each frame of the video sequence with the corresponding time delayed version of the input frame, wherein each frame is divided into a plurality of coding tree units (CTU). The pre-analyzing also includes the step of analyzing the video sequence at CTU level for each frame to collect the statistical parameters at block level by means of a statistics collector and further includes the step of mapping the input video sequence into one of the pre-defined classes based on the activity statistics of current frame.

According to the preferred embodiment, the step of comparing does the comparison between the collocated-CTUs of two adjacent frames. And further initial frames of each segment of video sequence are pre analyzed for classifying the corresponding video segment. Each segment is a portion of the video sequence i.e. a small portion in a larger video sequence.

According to another embodiment, the invention discloses a system for real time video encoding. The system includes a sequence classifier module to pre-analyze an input video sequence to map the video sequence into one of the pre-defined classes based on statistical parameters of the video sequence. The system also includes at least one threshold decider to provide the likely mode of encoding techniques to each of the pre-analyzed video sequence based on the pre-defined classes.

According to a preferred embodiment, the sequence classifier module comprises an activity measuring unit to receive the inputting video sequence and a time delayed version of the video sequence, wherein the activity measuring unit compares each frame of the video sequence with the corresponding time delayed version of the input frame. The sequence classifier module further includes a statistics collector to collect the statistical parameters of the current frame. The sequence classifier module also includes a sequence categorizer to map the input sequence to one of the prior-defined classes based on the statistical parameters of the current frame.

The present invention makes use of video content properties or characteristics to reduce the computation complexity without compromising on video quality. Thus, the method and system disclosed in the present invention provides a real time video encoding technique with less complexity and at the same time with optimal video quality.

### BRIEF DESCRIPTION OF THE DRAWINGS

The foregoing and other features of embodiments will become more apparent from the following detailed description of embodiments when read in conjunction with the accompanying drawings. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus, in the interest of clarity and conciseness, the drawings are generalized in form, wherein

FIG. 1 illustrates the flow chart of the method of real-time video encoding, in accordance with one embodiment of the present invention.

FIG. 2 illustrates the flow chart of step of pre-analyzing the input video sequence, in accordance with one embodiment of the present invention.

FIG. 3 illustrates the block-diagram of the system for real-time video encoding, in accordance with one embodiment of the present invention.

FIG. 4 illustrates the block-diagram of the sequence classifier module, in accordance with one embodiment of the present invention.

FIG. 5 illustrates the block-diagram of the system in accordance with the preferred embodiment of the present invention.

FIG. 6 illustrates the table for the configuration of machine used for profiling the system, in accordance with one of the preferred embodiment of the present invention.

FIG. 7 illustrates the table of encoding time saving and quality degradation for corresponding sequences, in accordance with one of the preferred embodiment of the present invention.

FIG. 8 illustrates the table of encode configuration details, in accordance with one of the preferred embodiment of the present invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable a person skilled in the art to practice the invention, and it is to be understood that other embodiments may be utilized and that logical, mechanical, and other changes may be made within the scope of the embodiments. The following detailed description is, therefore, not be taken as limiting the scope of the invention, but instead the invention is to be defined by the appended claims.

The present invention provides a method and system for real-time video encoding using pre-analysis based preliminary mode decision. The method comprises inputting a video sequence and a time delayed version of the video sequence into a comparator.

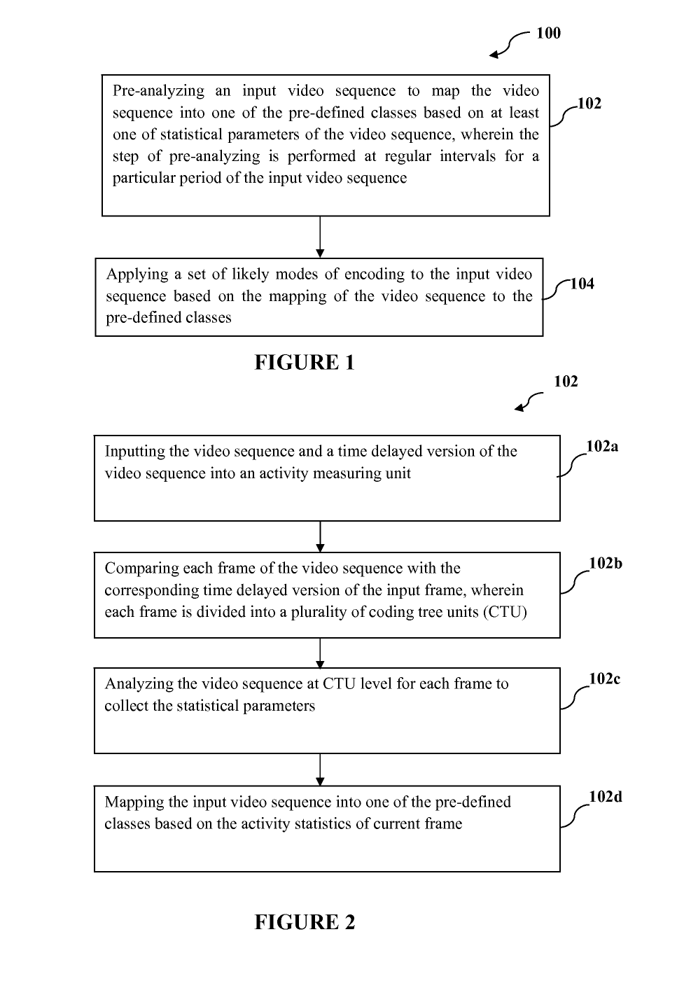

FIG. 1 illustrates the flow chart of the method of real-time video encoding, in accordance with one embodiment of the present invention. The invention discloses a method 100 for real time video encoding. The method includes a step 102 of pre-analyzing an input video sequence to map the video sequence into one of the pre-defined classes based on statistical parameters of the video sequence. The step 102 of pre-analyzing is performed at regular intervals for a particular period of the input video sequence. Normally the pr-analysis is done at dynamic intervals i.e. it is done based on the frame rate or at intervals of half the frame rate. Most frequently used frame rates are 25, 30, 50, 60 fps (frames per second). The frame rate is the number of frames encoded or decoded per second.

The method also includes the step 104 of applying a set of likely modes of encoding to the input video sequence based on the mapping of the video sequence to the pre-defined classes. For the identified category, modes that are unlikely to win are filtered out.

Now referring to FIG. 2, which illustrates the flow chart of step of pre-analyzing the input video sequence, in accordance with one embodiment of the present invention. The step 102 of pre- analyzing the input video sequence includes the following steps. The first step 102a is of inputting the video sequence and a time delayed version of the input video sequence into an activity measuring unit. The activity measuring unit may be a comparator. The pre-analyzing step 102 further includes the step 102b of comparing each frame of the video sequence with the corresponding time delayed version of the input frame, wherein each frame is divided into a plurality of coding tree units (CTU) and the corresponding CTUs of two adjacent frames (which are either in encode order or capture order) are compared. The pre-analyzing step 102 also includes the step 102c of analyzing the video sequence at CTU level for each frame to collect the statistical parameters including at least one of spatial or temporal activity at block level by means of a statistics collector. The temporal activity is measured by comparing the input frame with the timed delayed version of the input frame, whereas the spatial activity is measured within the input frame. The activity statistics of current frame are used to map the input sequence to one of the pre-defined classes. The step 102 of pre-analyzing further includes the step 102d of mapping the input video sequence into one of the pre-defined classes based on the activity statistics of the current frame. The statistical parameters such as spatial and temporal activity levels and different thresholds are used to classify the sequence to one of the following pre-defined classes:

1. Video conference—still video (negligible motion)

2. Video conference—low motion

3. Low motion

4. Medium motion

5. High motion

6. Random motion

7. Miscellaneous

According to an embodiment of the invention, once a sequence is categorized to one of above mentioned pre-defined class, the corresponding sub-set of coding option combinations only is selected for evaluation. The encoding process evaluates only this pre-defined/prescribed combination of coding options for final mode-decision. The system has cautiously built a relationship between these categories to prescribe a sub-set of modes for each sequence category. Below are the list of areas where all coding options are prescribed based on the category:

1) Limit coding unit (CU) depths to be evaluated, that is at any point of time two depths evaluated includes maximum and minimum CU sizes for each Coding Tree Unit (CTU)

2) Limiting Intra mode evaluation to particular group of Coding Tree Units (CTUs)

3) Limiting the number of intra modes to be evaluated for a given Coding Tree Unit (CTU) and/or Coding Unit (CU)

4) Pre-determining the skip Coding Tree Unit (CTU) and/or Coding Unit (CU) CTUs/CUs

5) Possible identification of Sample Adaptive Offset (SAO) type for all CTUs

6) Limiting the number of Motion estimation search points

7) Decision of Lagrangian multiplier i.e., Lambda (λ) for RD-cost function

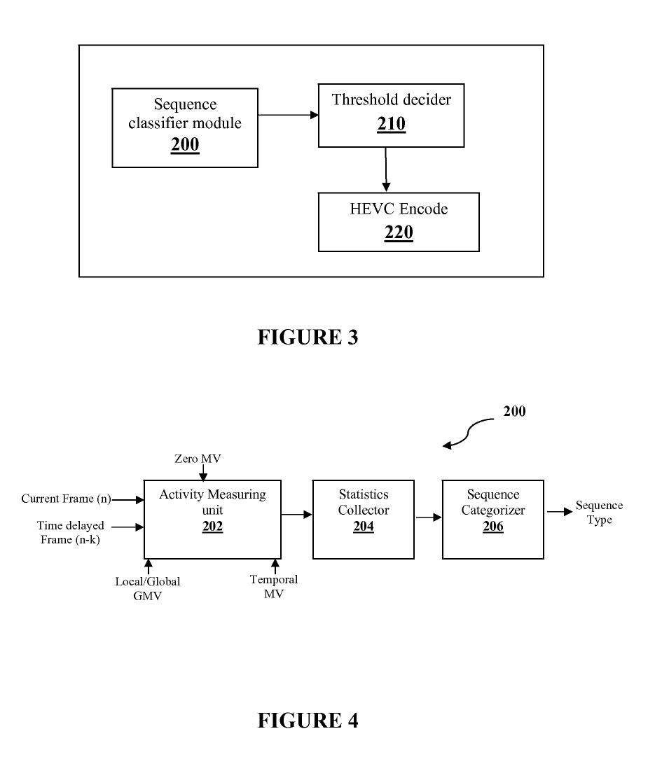

FIG. 3 illustrates the block-diagram of the system for real-time video encoding, in accordance with one embodiment of the present invention. The system includes a sequence classifier module 200 to pre-analyze an input video sequence to map the video sequence into one of the pre-defined classes based on statistical parameters. The system also includes at least one threshold decider 210 to provide the likely modes of encoding techniques to each of the pre-analyzed video sequence based on the pre-defined classes and hence, results in HEVC encoding 220.

Now referring to FIG. 4, which illustrates the block-diagram of the sequence classifier module, in accordance with one embodiment of the present invention. The sequence classifier module 200 includes an activity measuring unit 202 to receive the inputting video sequence and a time delayed version of the video sequence, wherein the activity measuring unit compares each frame of the video sequence with the corresponding time delayed version of the input frame. The activity measuring unit 202 measures the temporal or spatial activity of the current frame. The activity measuring unit 202 may be a comparator. The sequence classifier module 200 further includes a statistics collector 204 to collect the statistical parameter of the video sequence at frame-level. Here each frame is divided into a plurality of coding tree units (CTU) and the corresponding CTUs of two adjacent frames (which are either in encode order or capture order) are compared. The activity measuring unit analyzes the video sequence at CTU level for each frame to collect the statistical parameters. The statistical parameters include the temporal and spatial activity of the current frame. The temporal activity is measured by comparing the input frame with the timed delayed version of the input frame, whereas the spatial activity is measured within the input frame. The sequence classifier module 200 also includes a sequence categorizer 204 to map the input sequence to one of the pre-defined classes based on the activity statistics of the current frame. The spatial and temporal activity levels and different thresholds are used to classify the sequence to one of the below prior-defined category set:

1. Video Conference—Still video (Negligible motion)

2. Video Conference—Low motion

3. Low motion

4. Medium motion

5. High motion

6. Random motion

7. Miscellaneous

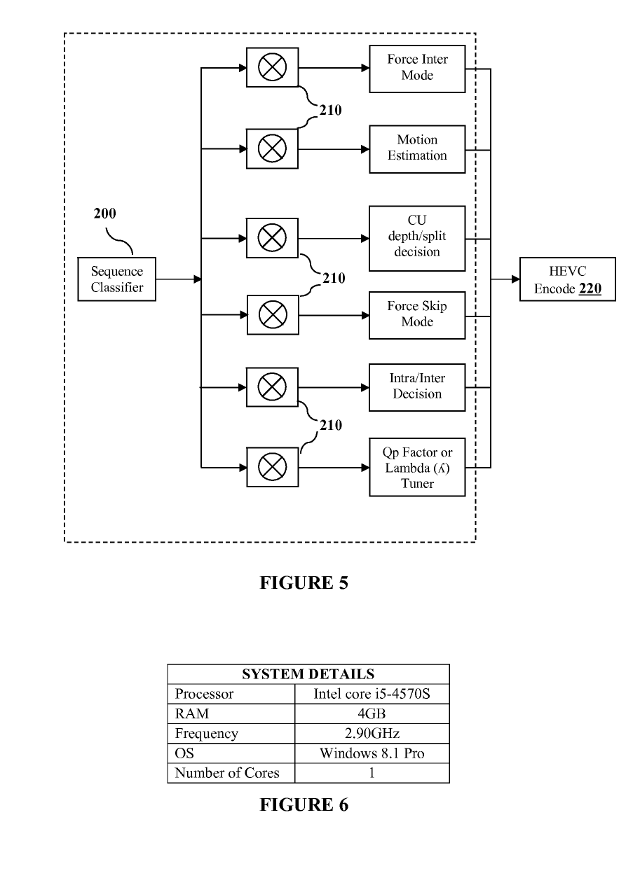

Now referring to FIG. 5, which illustrates the block-diagram of the system in accordance with the preferred embodiment of the present invention. The system includes the sequence classifier 200 connected with multiple threshold deciders 210. The functionality of threshold decider 210 is to decide particular threshold for a fast algorithm. Each threshold decider 210 receives output of the sequence classifier 200 and decides a set of likely modes applicable to the corresponding segment of the video sequence. Modes that are not likely for the identified category are filtered out. Since unlikely modes are filtered out dynamically using video content properties or characteristics, computation complexity is significantly reduced with less or no compromise in video quality, wherein pre-analysis of each frame is avoided. The following are the list of areas where all coding options are prescribed based on the category:

1) Limit coding unit (CU) depths to be evaluated, that is at any point of time two depths evaluated includes maximum and minimum CU sizes for each Coding Tree Unit (CTU)

2) Limiting Intra mode evaluation to particular group of Coding Tree Units (CTUs)

3) Limiting the number of intra modes to be evaluated for a given Coding Tree Unit (CTU) and/or Coding Unit (CU)

4) Pre-determining the skip Coding Tree Unit (CTU) and/or Coding Unit (CU) CTUs/CUs

5) Possible identification of Sample Adaptive Offset (SAO) type for all CTUs

6) Limiting the number of Motion estimation search points

7) Decision of Lagrangian multiplier i.e., Lambda (λ) for RD-cost function

The system and the method according to the present invention may be implemented using at least one processor. It is possible to implement the present invention even using a multi-core implementation also

For example, in case of “force skip mode”, for each sequence type, threshold, i.e. spatial or temporal activity threshold may be different for generation of skip modes. In case of video conferencing sequences, higher activity even generate skip modes. But in case of fast motion sequences, only blocks with less spatial or temporal activity may be coded as skip modes. Thus, function of threshold decider is to decide this threshold based on sequence type. Next block “Force skip mode”, decides either to force skip or to evaluate all modules along with skip based on this threshold. Same applies for all other algorithms. At the end, the encoder may be limited to evaluate only few candidates for any algorithm mentioned in the description.

FIG. 6 illustrates the table for the configuration of machine used for profiling the system, in accordance with one of the preferred embodiment of the present invention. The preferred embodiment utilizes a system with Intel core i5-4570S processor, 4 GB Ram, 2.90 GHz frequency, windows 8.1 pro with single core. The above illustrated system configuration is only a sample and any other such system is also possible to be used.

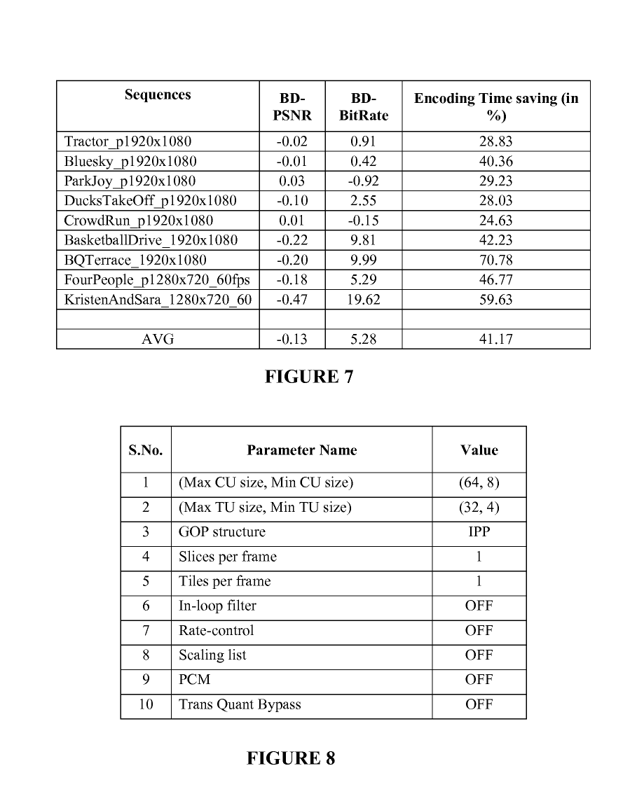

FIG. 7 illustrates the table of encoding time saving and quality degradation for corresponding sequences, in accordance with one of the preferred embodiment of the present invention. The table illustrates BD-bit rate increase and encoding time saving for each video sequence encoded by enabling present invention. Summarizing the results, above stated invention saves encoding time of 41.17% with BD-bit rate degradation of 5.28. FIG. 8 illustrates the table of encoder configuration details, in accordance with one of the preferred embodiment of the present invention. The encoding modes utilized includes the following,
Limit CU depths to be evaluated that is at any point of time two depths, at max, get evaluated
Limiting Intra evaluation to particular group of Coding Tree Units (CTUs)
Limiting intra modes to be evaluated
Limiting the Motion estimation search points
Decision of Lagrangian multiplier i.e., Lambda (λ) for RD-cost function

The above explained sample (FIG. 6-8) is purely by way of example and not as a limitation; there are many combinations in which the present invention may be implemented. The scope of the invention is to be defined only by the claims appended hereto, and by their equivalents.

Thus, it is understood from the above explanation that the pre-analysis is repeated at regular intervals for classifying multiple segments of the video sequence. A set of initial frames of each segment is pre-analyzed for classifying the corresponding segment. Based on the category, most likely modes of encoding are decided. For the identified category, modes that are unlikely to win are filtered out. Since unlikely modes are filtered out dynamically using video content properties or characteristics, computation complexity is significantly reduced with less or no compromise in video quality, wherein pre-analysis of each frame is avoided. Hence, the method and system disclosed in the present invention provides a real time video encoding technique with less complexity and at the same time with optimal video quality.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method for real time video encoding, the method comprises the steps of:
pre-analyzing an input video sequence to map the video sequence into one of a plurality of pre-defined classes based on at least one of statistical parameters of the video sequence, wherein the step of pre-analyzing is performed at regular intervals for a particular period of the input video sequence;
applying a set of likely modes of encoding to the input video sequence based on the mapping of the video sequence to the pre-defined classes.

2. The method as claimed in claim 1, wherein the step of pre-analyzing includes steps of:
inputting the video sequence and a time delayed version of the video sequence into an activity measuring unit ;
comparing each frame of the video sequence with the corresponding time delayed version of the input frame, wherein each frame is divided into a plurality of coding tree units (CTU);
analyzing the video sequence at CTU level for each frame to collect the statistical parameters; and
mapping the input video sequence into one of the pre-defined classes based on the activity statistics of current frame.

3. The method as claimed in claim 2, wherein the step of comparing does the comparison between the collocated-CTUs of two adjacent frames.

4. The method as claimed in claim 1, wherein initial frames of each segment of video sequence are pre analyzed for classifying the corresponding video segment.

5. The method as claimed in claim 1, wherein the likely mode is to limit coding unit (CU) depths, wherein the CU depths evaluated includes maximum and minimum CU sizes for each Coding Tree Unit (CTU).

6. The method as claimed in claim 1, wherein the likely mode of encoding is limiting intra mode evaluation to particular group of Coding Tree Units (CTUs).

7. The method as claimed in claim 1, wherein the likely mode of encoding is limiting the number of intra modes to be evaluated for a given Coding Tree Unit (CTU) and/or Coding Unit (CU)

8. The method as claimed in claim 1, wherein the likely mode of encoding is pre-determining the skip Coding Tree Unit (CTU) and/or Coding Unit (CU).

9. The method as claimed in claim 1, wherein the likely mode of encoding is possible identification of Sample Adaptive Offset (SAO) type for all Coding Tree Units (CTUs).

10. The method as claimed in claim 1, wherein the likely mode of encoding is, limiting the number of motion estimation search points.

11. The method as claimed in claim 1, wherein the likely modes of encoding is decision of Lagrangian multiplier.

12. The method as claimed in claim 1, wherein the method is implemented using at least one processor.

13. A system for real time video encoding, the system comprises:
a sequence classifier module 200 to pre-analyze an input video sequence to map the video sequence into one of a plurality pre-defined classes based on at least one of statistical parameters of the video sequence; and
at least one threshold decider 210 to provide the likely modes of encoding techniques to each of the pre-analyzed video sequence based on the pre-defined classes.

14. The system as claimed in claim 13, wherein the sequence classifier module 200 comprises an activity measuring unit 202 to receive the inputting video sequence and a time delayed version of the input video sequence, wherein the activity measuring unit 202 compares each frame of the video sequence with the corresponding time delayed version of the input frame to measure the statistical parameter of the current frame.

15. The system as claimed in claim 13, wherein the sequence classifier module 200 further comprises a statistics collector 204 to collect the statistical parameters of the current frame.

16. The system as claimed in claim 13, wherein the sequence classifier module 200 further comprises a sequence categorizer 206 to map the input sequence to one of the prior-defined classes based on the statistical parameters of the current frame.

17. The system as claimed in claim 13, wherein the likely mode of encoding is to limit coding unit (CU) depths, wherein the CU depths evaluated includes maximum and minimum CU sizes for each Coding Tree Unit (CTU).

18. The system as claimed in claim 13, wherein the likely mode of encoding is limiting Intra mode evaluation to particular group of Coding Tree Units (CTUs).

19. The system as claimed in claim 13, wherein the likely mode of encoding is limiting the number of intra modes to be evaluated for a given Coding Tree Unit (CTU) and/or Coding Unit (CU).

20. The system as claimed in claim 13, wherein the likely mode of encoding is pre-determining the skip Coding Tree Unit (CTU) and/or Coding Unit (CU).

21. The system as claimed in claim 13, wherein the likely mode of encoding is possible identification of Sample Adaptive Offset (SAO) type for all CTUs.

22. The system as claimed in claim 13, wherein the likely mode of encoding is limiting the number of motion estimation search points.

23. The system as claimed in claim 13, wherein the likely mode of encoding is decision of Lagrangian multiplier.

24. The system as claimed in claim 13, wherein the system further comprises at least one processor.
